(19) United States
(12) Patent Application Publication
(10) Pub. No.: US 2008/0318190 A1
(43) Pub. Date: Dec. 25, 2008

(54) Polymerizable Dental Pulp Healing, Capping, and Lining Material and Method for Use

(75) Inventors: Byoung Suh, Oak Brook, IL (US); Rui Yin, Buffalo Grove, IL (US); Mark Cannon, Kenilworth, IL (US); David E. Martin, Chicago, IL (US)

Correspondence Address: ICE MILLER LLP, ONE AMERICAN SQUARE, SUITE 3100, INDIANAPOLIS, IN, 46282-0200, US

(73) Assignee: Bisco, Inc., Schaumburg, IL (US)

(21) Appl. No.: 12/034,093

(22) Filed: Feb. 20, 2008

Related U.S. Application Data
(60) Provisional application No. 60/902,301, filed on Feb. 20, 2007.

(51) Int. Cl. A61C 5/04

(52) U.S. Cl. 433/228.1

(57) ABSTRACT

Dental pulp healing lining or capping compositions and methods of using the composition to treat an exposed, nearly exposed, or breached pulp chamber are disclosed herein. Embodiments include dental pulp healing lining or capping compositions comprising a resin portion having at least one hydrophilic monomer component and at least one hydrophobic monomer component and a calcareous material operable to both provide a biological seal and maintain an alkaline pH for extended periods. Further, light curable compositions are disclosed, allowing for improved curing properties, and allowing permanent restorations to be adhered to the sealed tooth without waiting a significant amount of time for the Portland cement portion to cure.

### PRIORITY

This application claims priority to U.S. Provisional Patent Application Ser. No. 60/902,301, entitled POLYMERIZABLE DENTAL PULP HEALING, CAPPING, AND LINING MATERIAL AND METHOD FOR USE, incorporated by reference herein.

### BACKGROUND

The invention relates to dental compositions, and more specifically, to a lining or capping material used in dental restorations for preserving dental pulp vitality.

Despite its general appearance as a solid, lifeless body, FIG. 1 shows that the mammalian tooth 10 is a complex structure, having multiple tissue layers and a central pulp chamber 40 filled with blood vessels, nerves, and odontoblasts, collectively referred to as the dental pulp 50. As can be seen, the pulp chamber 40 is surrounded by a layer of mineralized connective tissue with an organic matrix of tubules and collagenous proteins, collectively known as dentin 30. On the superior side of tooth 10, dentin 30 is covered by a protective layer of enamel 20, an extremely hard and dense substance which comprises approximately 90% calcium salts. In function, enamel 20 and dentin 30 function to protect the sensitive, soft tissues comprising dental pulp 50, from the acidic, biologically active conditions present in the mouth, as well as the considerable stresses placed upon tooth 10 set within gingival tissue and underlying bone 45 during mastication.

Among the three major “structures of the tooth, enamel, dentin and the soft tissue pulp, both dentin and pulp are considered vital and sensitive. Although enervation and blood supply are encountered only in the pulp, dentin is physiologically linked to the pulp by the dentinal fluid that permeates the entire structure of dentin within the dentinal tubules. Because of this hydraulic connection any injury affecting the external portion of the tooth will immediately be sensed by the pulp, which will respond in a defensive manner against the attack. The more the injury (trauma, caries) approaches the confined chamber of the pulp, the more the pulp requires professional intervention to aid its intrinsic ability to heal. Professional intervention should be directed to not only remove the aggressive element, but also to help pulp healing and protect the dentin pulp complex against further injury.

Severe mechanical trauma or breach of the enamel and dentin by substantial cavity formation from dental caries erosion 100 can cause exposure of the pulp chamber 40 of tooth 10 to the oral cavity as shown in FIG. 2, or may significantly reduce the dentin layer protecting the pulp chamber 40 as shown in FIG. 3. Such breach or trauma allows the sensitive dental pulp 50 to be irritated or become infected, which can lead to severe pain for the individual, systemic infection, and/or loss of vitality of dental pulp 50, which ultimately leads to loss of the tooth 10 or invasive endodontic treatment, such as a root canal.

Traditionally, when substantial portions of a tooth were damaged, broken off, or breached by caries, the tooth was extracted or endodontically treated due to the near certainty of infection of the dental pulp, and loss of vitality resulting in infection, loss of the tooth, and resultant pain to the individual. In addition, even in circumstances where the dental pulp vitality was maintained, researchers and practitioners questioned whether the dental pulp would be able to regenerate the dentin to reproduce the pulp chamber and provide a basis for any dental restoration thereon.

However, advances in the field of dentistry identified that removal of the tooth or dental pulp is not always required when breach or near breach of the pulp chamber occurs. Calcium hydroxide (Ca(OH)₂) was reported early on as a composition useful in vital pulp therapy and as a protective agent for the so-called dentin/pulp complex. Its ability to trigger regeneration of pulp tissue was first described in 1930. Hermann B W, Dentinobliteration der wurzel-kanalen nach behandlung mit calcium, Zahn Rundschau 39:888-899 (1930). When applied directly over the exposed pulp tissue in a pure powder or aqueous solution, Ca(OH)₂ was reported to cause an immediate surface, chemical cauterization that destroys part of the tissue. This feature led researchers to seek formulations that could induce healing without sacrificing the remaining tissue, starting with powdered formulations of Ca(OH)₂ that were admixed with water prior to application to the tooth pulp or dentin. Although the exact mechanism by which Ca(OH)₂ generates pulp healing by the induction of dentin bridge formation (formation of a new, reparative dentin that occludes the pulp exposure site and separates it from the external environment, thus enclosing the exposed pulp again in the chamber), it is well accepted that the high pH of its formulations (ca. 11-13) has been regarded as one, if not the major factor. Stanley, Criteria for standardizing and increasing credibility of direct pulp capping studies Am J Dent 11 Sp. Iss. (1998).

A commercial two component paste/paste Ca(OH)₂ based pulp liner formulations is named Dycalt currently marketed by Dentsply. A single component/visible light cure formulation also employing Ca(OH)₂ is commercially marketed by Dentsply under the name PRISMA® VLC™ Dycal®.

More recently, it has been reported that achieving hemostasis in exposed dental pulp, coupled with the creation of a biological seal over the disinfected pulp chamber, prevents infection from oral contaminants and greatly increases the likelihood of prolonged dental pulp vitality and regeneration of dentin microtubules, and dentin bridges. See, e.g., Kopel, H.; J. of Dent. Child; September-October 1997. In addition, the use of calcium hydroxide compositions, when placed in direct contact with dental pulp tissue, has been shown to increase the likelihood of preserving pulp vitality, likely due to bacteriostatic or bacteriocidal action from the high pH environment created by calcium hydroxide. Id. For this reason, the use of calcium hydroxide, including calcium hydroxide-based formulations for dental applications such as those disclosed in U.S. Pat. No. 3,047,408 to Dougherty, et al., have been used by some dental practitioners when patients suffer a trauma exposing the pulp or a caries-created cavity nearing the pulp cavity. Likewise, calcium phosphate has been shown to have similar effects when used as a pulp cap liner. Dickens, S. et. al; Dent Mater; September 2003; Mechanical Properties and Biochemical Activity of Remineralization in Resin-Based calcium phosphate cements.

However, studies suggest that a hermetic seal of the exposed or nearly exposed pulp chamber is more important to long term pulp survival than the use of calcium hydroxide when the pulp cavity has been exposed, or when the dentin layer covering the pulp cavity is nearly breached. See Kopel, H.; J. of Dent. Child; September-October 1997; The Pulp Capping Procedure in Primary Teeth “Revisited.” Further, calcium hydroxide is a highly soluble form of calcium that readily washes out with pulpal fluid, allowing its bacteriostatic properties to become nonexistent before the dental pulp is allowed to regenerate dentin and dentin bridges to produce a new pulp cavity. Id. Finally, calcium hydroxide interferes with bonding of resin-based dental restorations to the underlying dentin, and the high pH of calcium hydroxide can further neutralize the acid etching process used to help ensure a strong bond of the restoration to the underlying tissue, especially since calcium hydroxide compositions are typically added over the pulp cap prior to using a final restorative material such as a resin composites, glass ionomers, or amalgam. Id. Due to these problems, restorations produced by using a calcium hydroxide or calcium hydroxide—based formulation liner often fail or must be recreated due to poor bonding or erosion of the liner, allowing bacteria to invade the pulp cavity, requiring the patient to return to the clinician to have the tooth removed or the restoration replaced.

In response to these shortcomings, methods of using restoration materials consisting of Portland cements have been proposed. The relative advantages of such cement formulations are that its diffusion to the soft, exposed pulp is limited and the chemical destruction of the sound tissue is minor. Additionally, the cement formulation is significantly less soluble and is expected to last longer underneath the restorations as well as providing higher mechanical strength allows the material to be placed as a liner underneath restorations and support the load during application (in case of amalgams that are condensed) and subsequent mastication. For example, U.S. Pat. Nos. 5,415,547 and 5,769,638 to Torabinejad et al. suggest the use of a traditional or fast-set Portland cement having a calcium component of about 50-70% and a silicon dioxide component of about 21% as a filling material, with said material setting when hydrated. However, as noted in those references, the Portland cement filling compositions require traditional filling materials to be used as the final permanent restorative as Portland cement does not have sufficient wear properties. Further, a temporary filling must be used for the first 24 hours after the cement filling or pulp cap has been applied, requiring a patient to return to the dentist the next day to have the temporary filling removed and a permanent filling inserted as the wear surface once the cement has hardened. These drawbacks, coupled with the difficulty to predict the working time of the filling material, make these compositions and methods logistically less desirable than traditional methods.

Currently available calcium-containing lining and capping materials are designed to be applied as both indirect and direct pulp capping agent. Direct pulp capping indicates application direct on the exposed pulp surface. In this case, the alkalinity of the material acts immediately on the tissue and triggers the pulp cells towards formation of new calcified tissue to close the exposure. Indirect pulp capping indicates application of the material on dentin surface, not in direct contact with the pulp. In this case, professional intervention occurred before the pulp became exposed and the calcium-containing material is mostly used for its protective effect against further injury that may migrate to the pulp through the dentinal tubules. A calcium-containing layer applied as a liner on the deepest part of the cavity will form a physical barrier against the intrusion of potentially aggressive agents into dentinal tubules. Additionally, it is expected that such calcium-containing materials will promote a distant healing effect on the pulp, even though not in direct contact with it. This is reportedly because the calcium content of the materials is released and that alkaline ion can travel across the remaining dentin thickness and reach the pulp to deliver its benefits. It is well understood however, that release of calcium occurs at the expense of the solubilization of the material. Ca(OH)₂ based cements are set hard through a simple acid-base reaction and this ionically-hardened material is indeed very soluble. However, a recent clinical study reports that the aforementioned Dycal® material comprising Ca(OH)₂ seemed to disappear under amalgam restorations over the years due to solubilization of the material induced by oral fluids migrating from marginal leakage. Pereira et al., Clinical evaluation of Dycal under amalgam restorations, Am J. Dent 3:67-70. Some believe that this solubility is necessary for prolonged activity of the alkaline effect. One benefit of Ca(OH)₂ that is considered additional to its ability to protect and heal dentin/pulp complex is its antibacterial property. Bacteria can not survive at such a high pH resulting from localized release of OH ions.

Other reported major shortcomings of Ca(OH)₂ as a direct or indirect pulp capping material alone or in cement formulations are that the strength of the material is low and its solubility over time leaves a gap underneath the restorations leading to sensitivity and potential microbial growth as the alkaline benefits are no longer there once the material is dissolved. Another major drawback is that such cements are not adhesive and do not improve sealing of dentin. Depending on the amount applied to cover dentin underneath an adhesive restoration, all the covered area will no longer be available for the bonding procedure and the overall retention and sealing may be compromised. Investigations into alternatives to traditional Ca(OH)₂ cements have lead to attempts to produce resin-based cements or lining or capping systems wherein one or more ethylenically unsaturated monomers are employed with Ca(OH)₂ or Portland cements or other filler compounds to create two component systems or one component systems capable of light curing. See, e.g. Lopez et al. US Published Application No. 20020045678; Yudha et al. U.S. Pat. No. 6,032,832; and PCT Published Application WO 01/12129 A1. The cement systems disclosed in Yudha et al. includes polymerizable unsaturated dicarboxylic acid compounds, (methyl)methacrylates copolymers such as Bis-GMA, and a metal chelate-forming inorganic powder. Yudha et al. characterize their systems as practically non-aqueous cement in which the resin component comprises a polymerizable monomer such as 2-hydroxyethyl methacrylate (2-HEMA) which is used as a reactive solvent to dissolve a carboxyl group-containing polymer along with an inorganic powder that forms a metal chelate in the presence of water. The root canal sealants and fillers and pulp capping material disclosed in WO 01/012129 A1 include biodegradable polymers, copolymers comprising acrylates and methacrylates such as 2-HEMA and triethylene glycol trimethacrylates. Lopez et al. disclose dental restorative compositions comprising an unsaturated resin portion that can comprise the aforementioned WO 01/0129129 biodegradable resins as well as other resin compounds such as traditional Bis-GMA compounds and a variety of acidic monomers such as DSDM, BPDM, a calcium silicate cement component and a non-water curing component (see Lopez et al., paragraphs 009-014), together with fillers and other components such as radiopaque materials such as barium sulfate and bismuth oxide.

However, attempts to follow the suggestions in the art have revealed that certain problems may exist. For example, use of BisGMA with acidic monomers such as DSDM as suggested in Lopez et al. but in the presences of relatively higher concentrations (above about 40 wt. percent) of Portland Cement III reveals that the one component systems gels and is not shelf-stable for long periods of time. Additionally, efforts to mix monomers such as BisGMA, triethylene glycol dimethacrylate (TriEDMA) with barium sulfate powders and Portland cements resulted in separation of the composition into different components, which was confirmed by microscopic examination of the miscibility of the composition in water. Removal of BisGMA and other conventional polymerizable monomers such as UDMA from the system, and attempts to cure polymerizable monomers such as the polyethylene glycol dimethacrylate (PEGDMA) taught by Lopez et al. showed very low bond strengths after curing.

Further analysis of these observations and applicants' related investigations has lead applicants to believe that the prior art has not appreciated or taught that a balance is needed between the hydrophobic and hydrophilic portions of the pulp lining or capping system to achieve both a desired initially hydrophilic characteristics to promote interaction with tooth dentin and a subsequent hydrophobic characteristic after polymerization relative to conventional Ca(OH)₂ systems to maintain good strength while allowing prolonged Ca and OH ion release to promote both pulp and dentin vitality and regrowth and increased pH in the repaired area. In addition, the acidity of the monomers needs to be considered, especially in the presence of relatively higher amounts of Portland cements or other calcium-containing materials that may interact with the acidic resins and cause undesirable gelling of the material during storage.

Therefore, it would be beneficial to provide pulp healing lining or capping material that provides both a lasting source of calcium in contact with the dentin tubules and an effective bonding to the underlying dentin. Such a pulp healing lining or capping material would provide a biologically sealed, basic environment with a mineral source for tissue regeneration and would preferably display an ability to seal dentin tubules, thereby reducing tooth sensitivity and biological permeability. In addition, a lining or capping material further displaying radiopaque properties and having the ability to be cured using dental light curing units well known in the art and/or light and self-cured would be appreciated.

### BRIEF DESCRIPTION OF THE DRAWINGS

FIG. 1 shows a cross-section rendering of a mammalian tooth, indicating its multiple tissue layers.

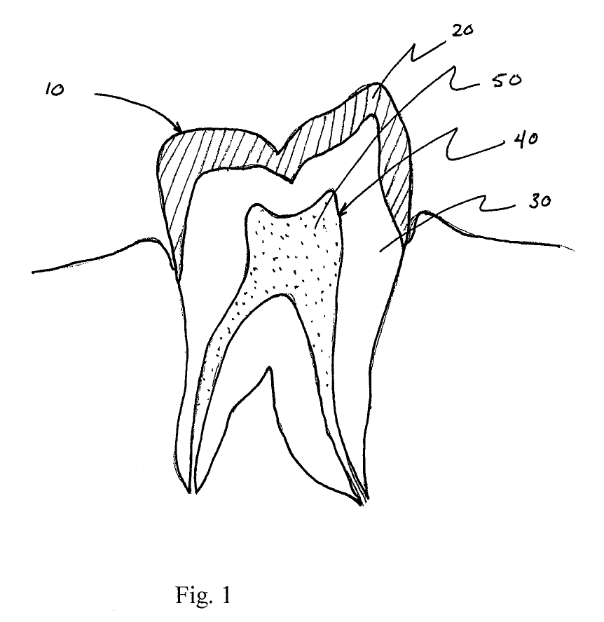

FIG. 2 shows a cross-section rendering of a mammalian tooth, showing dental caries erosion causing a breach of the pulp cavity.

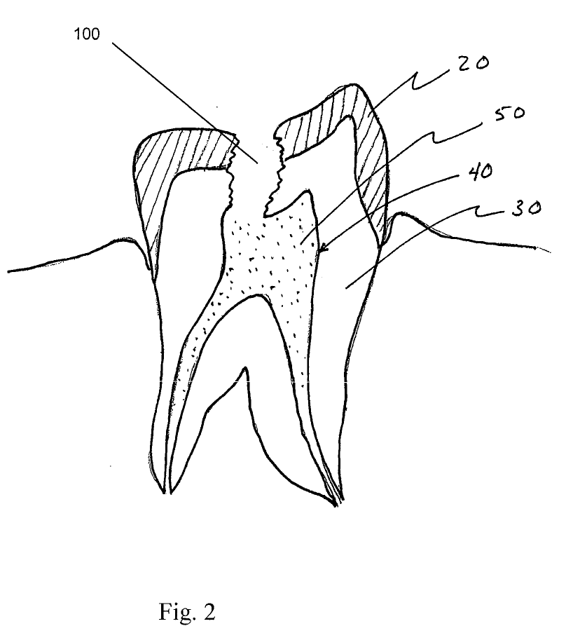

FIG. 3 shows a cross-section rendering of a mammalian tooth, showing caries erosion causing a near-breach of the pulp cavity.

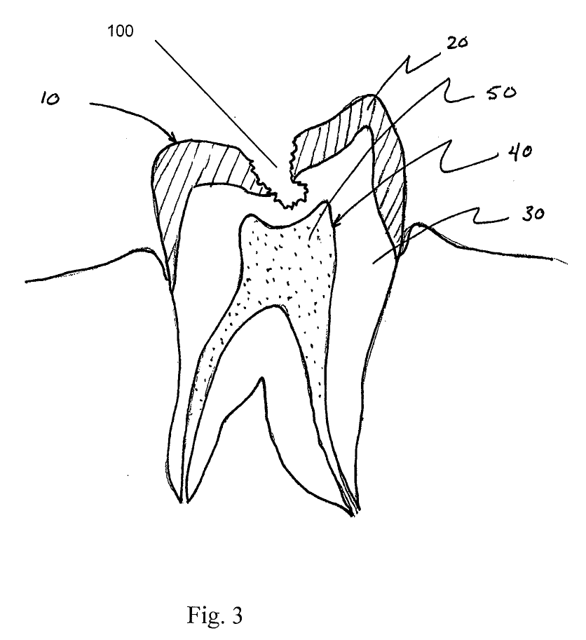

FIG. 4 shows a cross-section of a mammalian tooth utilizing the pulp cap barrier of the present invention for repair of an eroded tooth.

### SUMMARY

The present application relates to a dental pulp healing lining or capping composition comprising a resin portion and a calcareous portion combined together to form a homogenous mixture. In some presently preferred embodiments, the resin portion comprises a hydrophilic resin component and a hydrophobic resin component. In some presently preferred embodiments, the hydrophilic resin component comprises one or more hydrophilic monomers selected to promote interaction of the composition with the hydrophilic tooth dentin during initial application of the composition, and the hydrophobic resin component comprises one or more hydrophobic monomers selected to promote sustained release of Ca and OH ions after curing of the composition in place on the tooth pulp and/or dentin. In addition, the calcareous portion may comprise Portland cement powder, such as Portland type III cement powder. Certain embodiments of the present invention have shown sustained release of lower pH within an area surrounding a breach or near breach of a pulp cavity over long periods of time relative to conventional Ca(OH)₂ powder systems when applied to a tooth while exhibiting good mechanical properties and curability using light cure systems. In addition, certain embodiments have shown improved biological seal capabilities, thereby reducing loss of vitality in the pulp chamber.

According to another embodiment of the present invention, a dental pulp healing lining or capping composition comprising a resin and a calcareous portion is disclosed. For example, the resin portion may comprise approximately greater than 30% of the dental pulp healing lining or capping composition and the calcareous portion may comprise approximately greater than 30% of the dental pulp healing lining or capping composition. Further, according to one embodiment, the resin portion and calcareous portion are combined to create a substantially homogenous mixture so that the mixture is operable to be manipulated and cured to form a dental restoration.

In another preferred embodiment of the present invention, the pulp capping and lining material comprises about 40 to about 50 wt percent of a Portland cement powder component, and from about 30 to 40 wt percent of a hydrophilic monomer that is neutral or mildly acidic in nature, from about 5 to about 10 wt percent of a hydrophobic polymerizable monomer, and from about 5 to about 10 wt percent of a hydrophilic monomer or hydrophilic filler portion, alone or in combination with suitable light cure initiators and radiopaque materials, with the aforementioned components being miscible without significant separation in a single component system. Alternatively, the aforementioned components may be supplied in a two-component system comprising a light cure initiator in one of its components and wherein one component comprises a self-cure initiator combined with the Portland cement and non-polymerizable filler and optionally resin compounds that are not polymerized by contact with the self cure initiator and the other component includes resin compounds capable of polymerization upon contact with the self-cure initiator, and wherein the composition is also polymerizable upon activation of the light cure initiator.

### DETAILED DESCRIPTION

The present application relates to a dental pulp healing lining or capping material and method of use. In particular, the present application relates to a pulp healing lining or capping material operable to form a pulp cap barrier in an injured or eroded tooth and promoting pulp vitality once the pulp chamber has been breached or nearly breached.

According to one embodiment of the present invention, a dental pulp healing lining or capping material comprises a polymerizable resin portion and a calcareous compound or salt portion. Optionally, the dental pulp healing lining or capping material also comprises a radiopaque material with no or low mammalian toxicity (e.g., bismuth oxide (Bi₂O₃) and/or Barium Sulfate BaSO₄). Further optionally, the dental pulp healing lining or capping material may further incorporate a hydrophilic thickening or glidant material such as AEROSIL® 200 to impart additional hydrophilic characteristics to the composition, or AEROSIL® 972 silica (Degussa, Corp., Vernon Hills, Ill.) to change the consistency and/or flowability of the pulp healing lining or capping material as desired.

By way of nonlimiting example, the polymerizable resin portion may comprise an ethylenically unsaturated relatively hydrophobic monomer or combination of monomers such as Bis-GMA, other acrylates or methacrylate dental resins well known in the dental pulp healing lining or capping arts, as well as those having a composition the same as or similar to those disclosed in Table 1 below. In one embodiment, the hydrophobic monomer component may be combined with one or more hydrophilic monomers that are neutral or mildly acidic in nature, such as hydroxyl or polyethylene glycol acrylates and methacrylates to form a polymerizable resin according to one aspect of the present application. According to one aspect of the present application, at least one neutral or mildly acidic hydrophilic monomer is combined with at least one hydrophobic monomer to form the polymerizable resin portion of the dental pulp healing lining or capping material. For example, the at least one hydrophobic monomer such as BisGMA, ethoxylated BisGMA, urethane dimethacrylate (UDMA) or triethylene glycol dimethacrylate (Tri-EDMA) is combined with at least one hydrophilic monomer such as 2-hydroxyethyl methacrylate (2-HEMA) or polyethylene glycol dimethacrylate (PEGDMA) One of ordinary skill in the art will appreciate that other hydrophobic monomers and hydrophilic monomers can be used.

In addition, and as set out below, the use of other hydrophilic components such as AEROSIL® 200 in the composition has been found to facilitate prolonged release of OH ions from the composition comprising the aforementioned resins and Portland cement powder, such as Portland Cement type III. Consistent with the prior art teachings, it is expected that other Portland Cements types will have utility in the present invention when combined with applicants' novel resin compositions. See, e.g. Lopez et al. Published Patent Application 20020045678 regarding a discussion of available Portland Cement compositions and their uses in dental compositions.

The following resin formulations were prepared according to the methods set out below. All percentages of resin components are in weight percent of the total resin portion of the system, and percentages of the Portland cement and other components are provided as their weight percentages relative to the total weight of the entire system.

TABLE 1
Resin Formulations
Tri EDMA Formulation

| | Formula A | Formula B |
|---|---|---|
| Component | % by Weight | % by Weight |
| Tri EDMA w/ MEHQ | 57.48 | 70.1 |
| THFMA | 20.00 | 24.4 |
| EDMAB | 3.00 | 3.66 |
| MEHQ | 0.02 | 0.025 |
| Uvinul-3000 | 1.00 | 1.22 |
| Bis “A” DIMA | 18.00 | 0 |
| CQ | 0.50 | 0.80 |

| | |
|---|---|
| | Formula |
| Component | % by Weight |

Resin Formulation I

| | |
|---|---|
| UDMA | 38.00 |
| BisGMA | 32.00 |
| TRI EDMA Formulation A | 30.00 |

Resin Formulation II

| | |
|---|---|
| UDMA | 38.00 |
| BisGMA | 22.00 |
| TRI EDMA Formulation A | 30.00 |
| BPDM/GMA | 10.00 |

Resin Formulation III

| | |
|---|---|
| UDMA | 38.00 |
| BisGMA | 22.00 |
| TRI EDMA Formulation A | 30.00 |
| HEMA | 10.00 |

Resin Formulation IV

| | |
|---|---|
| UDMA | 38.00 |
| BisGMA | 22.00 |
| TRI EDMA Formulation B | 30.00 |
| BPDM | 5.00 |
| HEMA | 5.00 |

Resin Formulation V

| | |
|---|---|
| UDMA | 38.00 |
| BisGMA | 27.00 |
| TRI EDMA Formulation B | 30.00 |
| BPDM | 5.00 |

Resin and Initiator Formulation VI

| | |
|---|---|
| BisGMA | 20.00 |
| PEGDMA | 77.25 |
| EDMAB | 2.4 |
| CQ | 0.32 |
| MEHQ | 0.032 |

Further, the calcareous compound or salt used in the dental pulp healing lining or capping material may comprise calcium phosphate, Portland cement, calcium carbonate, calcium oxide, or other calcium-based compounds having a basic pH. As is well known in the art, various formulations of Portland cement exist and all are expected to be appropriate for purposes of this application. However, for purposes of the exemplary embodiments below, the cement used was white type III Portland cement having a composition approximately similar to the composition noted in Table 2 below. One of ordinary skill in the art will appreciate that other formulations including various fillers, colorants, and bleaching agents may further comprise the dental pulp healing lining or capping material.

TABLE 2
Portland Cement Type III Example

| | |
|---|---|
| Chemical | % By Weight |

Chemical Composition

| | |
|---|---|
| SiO₂ | 21.82 |
| Al₂O₃ | 4.37 |
| Fe₂O₃ | 0.34 |
| CaO | 66.77 |
| MgO | 1.86 |
| SO₃ | 3.08 |
| Alkalies, Na₂O Equiv. | 0.10 |
| Loss on ignition (L O.I.) | 1.28 |
| 3CaO•SiO₂ | 67.0 |
| 2CaO•SiO₂ | 12.0 |
| 3CaO•Al₂O₃ | 10.9 |
| 4CaO•Al₂O₃•FE₂O₃ | 1.0 |

Physical Properties

| | |
|---|---|
| Fineness, Specific Surface | |
| Blaine m²/kg | 518 |
| #325 % Passing | 99.1 |
| Autoclave Expansion | 0.10 |
| Gillmore Set Time | |
| Initial minutes | 130 |
| Final minutes | 260 |
| Air Content | 5.5 |

| | Compressive Strength | |
|---|---|---|
| | psi | Mpa |
| 1-day | 3440 | 23.7 |
| 7-day | 6860 | 47.3 |
| 28-day | 7870 | 54.3 |

### Preparation

In one embodiment, a dental pulp healing lining or capping material may be formed by preparing a pulp cap powder comprising a calcareous compound or salt and any thickening agent or glidant that may be used in the dental pulp healing lining or capping material. Optionally, the pulp cap powder further comprises a radiopaque material such as bismuth oxide (BiO₂), ytterbium fluoride (YbF₃), barium sulfate (BaSO₄), or any other radiopaque material known in the art. Further optionally, a fumed silica such as Aerosil® brand fumed silica is utilized as a glidant, preferably Aerosil® 200 due to its hydrophilic properties. By way of nonlimiting examples, several pulp cap powder formulations are disclosed in Table 3 below. Once the individual ingredients comprising the pulp cap powder are combined and thoroughly mixed, the pulp cap powder is incrementally added to a selected resin through successive mixing cycles in order to thoroughly incorporate the pulp cap powder into the resin. Alternatively, each ingredient comprising the pulp cap powder was iteratively mixed with the resin portion.

TABLE 3
Powder Formulations

| | |
|---|---|
| | Formula |
| Component | % by Weight |

Type A

| | |
|---|---|
| Portland Cement (Type III) | 75.00 |
| Ytterbium Fluoride (YbF₃) | 15.00 |
| Aerosil R972 | 10.00 |

Type B

| | |
|---|---|
| Portland Cement (Type III) | 87.34 |
| Barium Sulfate (BaSO₄) | 12.66 |

Type C

| | |
|---|---|
| Portland Cement (Type III) | 87.65 |
| Barium Sulfate (BaSO₄) | 12.35 |

Type D

| | |
|---|---|
| Portland Cement (Type III) | 87.95 |
| Barium Sulfate (BaSO₄) | 12.05 |

Type E

| | |
|---|---|
| Portland Cement (Type III) | 88.24 |
| Barium Sulfate (BaSO₄) | 11.76 |

Type F

| | |
|---|---|
| Portland Cement (Type III) | 90.00 |
| Barium Sulfate (BaSO₄) | 10.00 |

Type G

| | |
|---|---|
| Portland Cement (Type III) | 89.90 |
| Barium Sulfate (BaSO₄) | 10.10 |

Resin and Powder Formulation H

| | |
|---|---|
| Portland Cement (Type III) | 44.0 |
| Fumed Silica | 7.0 |
| Barium Sulfate (BaSO₄) | 3.0 |
| Bismuth Oxide (Bi₂O₃) | 3.0 |
| Resin and Initiator | 43.0 |
| Formulation VI | |

Alternatively, each of the dry ingredients may be added to the resin separately, by way of successively adding the powder to the selected resin. For instance, the following methodology presents an exemplary embodiment of preparation of one formulation of a dental pulp healing lining or capping material formulations according to one aspect of the present application.

### EXAMPLE 1

TABLE 4

| Component | % | Wt (g) |
|---|---|---|
| Aerosil 200 | 14.00 | 2.80 |
| Resin and | 86.00 | 17.20 |
| Initiator | | |
| Formulation | | |
| VI | | |
| | 100 | 20.00 |

According to one exemplary embodiment, a resin paste comprising a glidant or thickeners such as Aerosil 200 and composite resin such as those described in Resin and Initiator Formula, or other resin formulations in Table 1 above is mixed in the proportions shown in Table 4. The resin and thickener described above were combined in a speed mixer of appropriate size, with the thickener being incrementally added over several mixing cycles at approximately 2,000 revolutions per minute to ensure a homogeneous mixture of the two components. In this example, five mixing cycles of one minute each were performed, with the glidant added at approximately 45% of the total thickener content in prior to the first cycle, 22.5% of the thickener content added prior to the second cycle, approximately 15% of the thickener content added prior to the third cycle, approximately 12.5% of the thickener added prior to the fourth cycle, and approximately 5% of the thickener added prior to the fifth cycle, with the walls of the speed mixer being scraped down between cycles. A final cycle of two minutes was then performed to ensure incorporation of all the thickener, with care being taken not to exceed 40° Celsius during any cycle.

Thereafter, the resin paste formulation was iteratively incorporated with both bismuth oxide and/or barium sulfate and Portland cement according to the methodology described above, and allowing the mixture to cool between cycles as needed to prevent the mixture from exceeding 40° Celsius at any time. The mixture was combined in the relative proportions as described in Table 5 below.

Specifically, in this example, five mixing cycles of one minute each were performed, with the bismuth oxide/barium sulfate added to the resin/thickener paste at approximately 45% of the total bismuth oxide/barium sulfate content in prior to the first cycle, 22.5% of the bismuth oxide/barium sulfate content added prior to the second cycle, approximately 15% of the bismuth oxide/barium sulfate content added prior to the third cycle, approximately 12.5% of the bismuth oxide/barium sulfate added prior to the fourth cycle, and approximately 5% of the bismuth oxide/barium sulfate added prior to the fifth cycle, with the walls of the speed mixer being scraped down between cycles. A final cycle of two minutes was then performed to ensure incorporation of all the bismuth oxide and/or barium sulfate, with care being taken not to exceed 40° Celsius during any cycle.

Finally, the type III Portland cement was added to the resin paste. Following the same procedures as the incorporation of the previous materials, the Portland cement was incorporated into the resin paste in one minute mixing cycles, with the Portland cement added at a rate of approximately 45%, 22.5%, 15%, 12.5%, and 5%, such that 100% of the Portland cement was added over five mixing cycles. Once the powdered portions comprising the dental pulp healing lining or capping material had been incorporated into the resin, a final mixing cycle of approximately one minute was used to promote homogenization of the composition. As has been noted before, care was taken to allow time between each mixing cycle so that the composition could cool, such that the composition temperature did not exceed 40° C.

TABLE 5
Combination of Resin/Thickener and Powder Percentages

| Description | % | Wt (g) |
|---|---|---|
| Resin/Thickener | 50.00 | 20.00 |
| Paste (Table 4) | | |
| Portland Type III | 45.00 | 18.00 |
| BaSO₄ | 5.00 | 2.00 |
| | 100.00 | 40.00 |

It should be noted that upon complete mixture of this exemplary formulation, the overall proportions of the abovementioned compositions comprising the dental pulp healing lining or capping material in the overall proportions shown in Table 6 below. It will be appreciated in the art that, in certain applications, the final mixing procedures may be performed under a vacuum to reduce air bubbles within the composition.

TABLE 6
Sample Dental Pulp healing lining or capping Material Formulation

| | % (by weight) |
|---|---|
| Portland Type III | 45.00 |
| Bi₂O₃ | 3.00 |
| BaSO₄ | 3.00 |
| Aerosil 200 | 7.00 |
| Resin and | 43.00 |
| Initiator | |
| Formulation | |
| VI | |
| | 100.00 |

The resultant dental pulp healing lining or capping material displays favorable depth of cure when exposed to a dental light curing unit well known in the art, such as the Bisco® VIP™ curing light, is radiopaque, has not shown signs of separation of the individual components when stored, and displays sufficient aesthetic properties to allow its use as a liner under a composite filling, or to be used as the complete restoration itself.

It will be appreciated that the overall formulation of the dental pulp healing lining or capping composition can be adjusted to display different properties, as desired for a particular application. For example, the thickener or glidant optionally comprises approximately less than 4% of the total dental pulp healing lining or capping composition, from about 4% to about 10% of the pulp healing lining or capping composition, or greater than about 10% of the dental pulp healing lining or capping composition. Similarly, the calcareous compound or calcium salt may comprise less than about 40% of the total weight of the dental pulp healing lining or capping composition, about 40% to about 45% of the dental pulp healing lining or capping composition, about 45% of the dental pulp healing lining or capping composition; about 45% to about 55% of the dental pulp healing lining or capping composition. Further, the radiopaque material may comprise about 3% to about 4% of the dental pulp healing lining or capping composition, about 4% to about 5% of the dental pulp healing lining or capping composition; about 5% to about 7% of the composition; or about 7% to 15% of the composition.

### Applications

In application, the dental pulp healing lining or capping materials described in the present application are intended to be used when the pulp chamber is breached or nearly breached. As discussed previously, when dental carries erosion progress through the enamel and into the underlying dentin, the bacteria-infected tissue is generally removed by a clinician through the use of high speed or low speed drills until sound, uninfected tissue is revealed. In the event that cariogenic tissue reaches the pulp chamber, or if only a small amount of dentin is left when the cariogenic tissue is removed, the pulp chamber or thin layer of dentin is optionally sealed with the dental pulp healing lining or capping composition according to the present application before additional restoration proceeds.

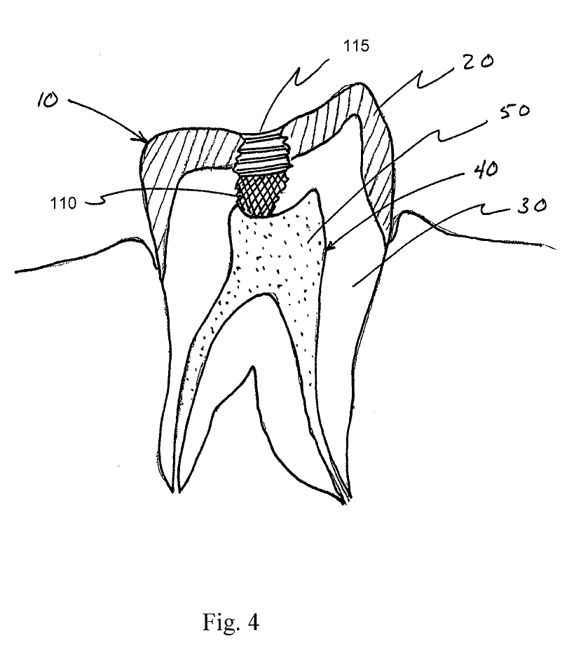

According to one embodiment of the present application, a dental pulp healing lining or capping material according to an aspect of the present application as discussed above is applied over the exposed pulp chamber or thin layer of dentin covering the pulp cavity to form a biological seal. As discussed above, typical clinical protocol recommends achieving hemostasis in any exposed dental pulp, followed by a disinfection of any exposed pulp cavity prior to sealing the pulp chamber. Thereafter, a clinician may optionally etch the exposed dentin and any enamel adjacent thereto to prepare the exposed tooth surface as shown in FIG. 4. Thereafter, a dental pulp healing lining or capping material 110 according to any of the aspects discussed above, is applied to the prepared surface of a tooth in such a manner that the exposed dentin and any breach of the pulp cavity is covered by the dental pulp healing lining or capping material. Once the dental pulp healing lining or capping material is in place, polymerization of the dental pulp healing lining or capping material 110 is initiated by the appropriate process. For example, a dental light curing unit is used to polymerize a dental pulp healing lining or capping material comprising a light-cure resin. Typically, the pulp capping material is applied in one or more layers of about 1 mm thickness or less, and more preferably in one or more layers that are cured by at least 20 seconds of light cure exposure between application of each layer up to a total thickness of about 0.7 mm or less. Optionally, a dental adhesive material may be applied to the pulp and dentin and cured in place before application of the lining or capping material of the present invention and/or the adhesive may be applied to the cured layers before application of additional layers of the capping or lining materials or the desired dental restorative material or device.

It will be appreciated that the dental pulp healing lining or capping material 110 may be used as a thin cap over the dentin or pulp chamber, providing a biological seal for the pulp cavity and a base upon which another restoration may be placed. For example, a pulp chamber capped by the dental pulp healing lining or capping material 110 serves as a base for a temporary or permanent crown, filling, or other restoration placed over the remaining tooth or dental pulp healing lining or capping material by methods known in the art. As shown in FIG. 4, a filling material 115 such as amalgam, resin based composite, or other dental resin or composition is used as a protective layer to provide a hard-wearing surface for protection of the dental pulp healing lining or capping material 110.

In application, it will be appreciated the dental pulp healing lining or capping material provides a biological seal for the pulp cavity, along with an alkaline calcium source that is less water soluble than previous calcium hydroxide compositions used, thereby providing a solidly secured pulp cap operable to bond well with other dental pulp healing lining or cappings or cements. In addition to the ability to provide an alkaline calcium source that does not impede the creation or maintenance of a biological seal around the pulp chamber, testing of multiple formulations of the dental pulp healing lining or capping material disclosed herein indicates that the dental pulp healing lining or capping materials disclosed in Table 7 below maintain their alkalinity in an acidic environment for a substantially longer period of time than previous calcium hydroxide formulations.

TABLE 7
Sustained Alkalinity and Stability Over Time

| | | | | | | VII |
|---|---|---|---|---|---|---|
| | | | | | | Room |
| | II | III | IV | | | Temperature |
| I | 45% Portland Cmt | 45% Portland Cmt | 45% Portland Cmt | | | Aging of Col. I |
| Dental Pulp | 5% BaSO₄ | 5% BaSO₄ | 5% BaSO₄ | | | Formula |
| healing lining or | 7.5% Aerosil 200 | 15% Aerosil R972 | 8.0% Aerosil 200 | V | VI | Stability |
| capping material | 42.5% Resin | 35% Resin | 42.0% Resin | Dycal | Dycal VLC | (No |
| Day | pH | pH | pH | pH | pH | separation = OK) |
| 1 | 11.21 | 10.911 | 11.288 | 11.67 | 8.599 | OK |
| 28 | 9.36 | 8.606 | 9.667 | 10.24 | 8.44 | OK |
| 49 | 8.03 | | | 9.70 | 8.06 | OK |
| 91 | 9.05 | | | 6.27 | 7.96 | OK |
| 112 | 9.21 | | | (Crumbled) | 7.50 | OK |
| 119 | 9.30 | | | | 7.36 | OK |
| 126 | 8.90 | | | | 7.25 | OK |
| | | | | | (Discontinued) | |
| 140 | 8.91 | | | | | OK |
| 160 | 8.88 | | | | | OK |
| 168 | 8.76 | 7.894 | 8.752 | | | OK |
| 175 | 8.36 | <7.6 | 8.752 | | | OK |
| | | (Discontinued) | | | | |
| 204 | 8.71 | | | | | OK |
| 265 | 8.33 | | 8.466 | | | OK |
| 490 | 8.75 | | | | | OK |
| 567 | 7.93 | | | | | OK |
| 686 | 7.95 | | 7.90 | | | OK |

As can be seen in the testing schedule of Table 7, each of the noted dental pulp healing lining or capping compositions were tested against a commercially available calcium hydroxide composition for pulp capping available under the brand name Dycal®E and Dycal® VLC. The testing comprised the process of placing a sample of the dental composition as noted in a 120 ml sample of deionized water and heating the water to 37° C. On each Monday, the sample was removed from the 120 mL solution and placed in a 20 mL testing container filled with deionized water and heated to 37° C. On each Tuesday, an Orion pH meter, Model 710A, was calibrated according to the instruction manual. A magnetic stir bar was added to the 20 mL sample container and the magnetic stirrer was adjusted to give the liquid a gentle movement past the electrode sensor of the Orion pH meter. At this point, and after being allowed to be cooled to room temperature the pH of the water was taken with the Orion pH meter. After measuring, the water was replaced with a new 120 mL amount of deionized water and the sample disk was placed in the new bath. Because the pH of blood is approximately 7.4, testing of a sample was discontinued after the eluate reached approximately 7.4, as it is theorized that the composition no longer provided the pH necessary to promote dentin formation or to act as a bacteriostat or bacteriocide. The numeric values and day noted above are a sample of the results, indicating that the various formulations of the dental pulp healing lining or capping composition according to the present application sustain a higher pH for a significantly longer period of time than previous calcium hydroxide compositions as well as the complete failure of the Dycal composition at day 112.

As will be appreciated by those in the art, the dental pulp healing lining or capping compositions disclosed herein provide a material that overcomes the previous difficulties in applying a calcium source while effectively sealing a breached or nearly breached pulp chamber. Further, the dental pulp healing lining or capping compositions disclosed herein overcome the shortcomings of previous calcium hydroxide formulations in that the basic pH of the composition is maintained for significantly longer periods of time and are not readily washed out or eroded by either pulpal fluid or liquids in the oral cavity. Finally, the dental pulp healing lining or capping compositions disclosed herein have properties that allow for more practical use than the use of Portland cement alone, and the compositions as described and claimed allow for effective bonding of resins even with the significant amounts of Portland cements used therein with good bonding strengths to tooth dentin. The present compositions also exhibit good miscibility and, as shown in Table 7 above, are stable as single component systems when stored in a single container. Although the dental pulp healing lining or capping compositions have been described in considerable detail with reference to certain versions thereof, other versions are possible, including the use of dyes and colorants well known in the art to color the dental pulp healing lining or capping compositions. Therefore, the spirit and scope of the appended claims should not be limited to the description of the preferred versions contained herein.

What is claimed is:

1. A dental pulp healing lining or capping composition comprising
a. a hydrophobic resin portion;
b. a hydrophilic portion comprising a hydrophilic resin component that is neutral or mildly acidic in nature;
c. a calcareous portion; and
d. wherein the hydrophobic resin portion and the hydrophilic portion are combined with the calcareous portion are combined to create a substantially homogenous mixture such that the mixture is operable to be manipulated and cured to form a stable composition that provides a pH of about 8.0 or higher after at least 170 days.

2. The dental pulp healing lining or capping composition of claim 1, further comprising a hydrophilic thickener.

3. The dental pulp healing lining or capping composition of claim 2, wherein the hydrophilic thickener portion comprises hydrophilic fumed silica.

4. The dental pulp healing lining or capping composition of claim 1, further comprising a radiopaque material.

5. The dental pulp healing lining or capping composition of claim 4, wherein the radiopaque material is ytterbium fluoride, bismuth oxide, or barium sulfate.

6. The dental pulp healing lining or capping composition of claim 1, wherein the calcareous substance is calcium phosphate, calcium oxide, or Portland cement.

7. The dental pulp healing lining or capping composition of claim 1, wherein the calcareous substance is type III Portland cement.

8. The dental pulp healing lining or capping composition of claim 7, wherein the calcareous substance comprises from about 40% to about 55% of the dental pulp healing lining or capping composition.

9. The dental pulp healing lining or capping composition of claim 8, further comprising a radiopaque material and a hydrophilic thickening agent.

10. The dental pulp healing lining or capping of claim 8, wherein at least one of the resins comprises a light curable monomer component and the composition comprises a light cure initiator capable initiating cure of the light curable monomer component.

11. A dental pulp healing lining or capping composition comprising
a. a resin portion comprising approximately greater than 30% of the dental pulp healing lining or capping composition;
b. a calcareous portion comprising approximately greater than 30% of the dental pulp healing lining or capping composition;
c. wherein the resin portion and calcareous portion are combined to create a substantially homogenous mixture such that the mixture is operable to be manipulated and cured to form a dental restoration; and
d. wherein the resin portion comprises at least one hydrophobic polymerizable monomer component and at least one hydrophilic polymerizable monomer component that are combined to form a stable composition that provides a pH of about 8.0 or higher after at least 170 days.

12. The dental pulp healing lining or capping composition of claim 10, wherein the resin portion comprises is a light curable monomer component and the calcareous portion is a Portland cement.

13. The dental pulp healing lining or capping composition of claim 10, further comprising a thickener and a radiopaque material.

14. The dental pulp healing lining or capping composition of claim 12, wherein the radiopaque material comprises approximately less than 8% of the composition, and the thickener comprises approximately less than 20% of the dental composition.

15. The dental pulp healing lining or capping composition of claim 13, wherein the calcareous material is a Portland cement, the resin is a light curable composite resin, the thickener is a hydrophilic fumed silica, and the radiopaque material is ytterbium fluoride, barium sulfate, or bismuth oxide.

16. The dental pulp healing lining or capping composition of claim 13, wherein the resin portion comprises approximately 40% to approximately 45% of the dental pulp healing lining or capping composition, the calcareous material comprises approximately 40% to approximately 50% of the dental pulp healing lining or capping composition, the thickener comprises approximately 6% to approximately 9% of the dental pulp healing lining or capping composition, and the radiopaque material comprises approximately 4% to approximately 8% of the dental pulp healing lining or capping composition.

17. The dental pulp healing lining or capping composition of claim 15, wherein the calcareous material is a Portland cement.

18. The dental pulp healing lining or capping composition of claim 15, wherein the resin portion comprises a light curable monomer.

19. The dental pulp healing lining or capping composition of claim 15, operable to sustain a pH about 8.0 or above for more than six months.

20. The dental pulp healing lining or capping composition of claim 15, operable to sustain a pH of about 8.0 or above for more than one year.

21. The dental pulp healing lining or capping composition of claim 19, operable to be placed over a breached pulp chamber of a tooth and cured, thereby forming a biological seal over the breached pulp cap chamber.

22. The dental pulp healing lining or capping composition of claim 20, further operable to promote dentin formation within the biologically sealed pulp chamber.

23. A dental pulp healing lining or capping composition for capping a breached pulp chamber, the dental pulp healing lining or capping composition comprising:
a. a Portland cement portion comprising approximately 40% to approximately 50% of the dental pulp healing lining or capping composition; and
b. a light curable composite resin portion comprising approximately 40% to approximately 50% of the composition and comprising at least one hydrophilic monomer and at least one hydrophobic monomer wherein the resin portion comprises at least one hydrophobic polymerizable monomer component and at least one hydrophilic polymerizable monomer component that are combined to form a stable composition that provides a pH of about 8.0 or higher after at least 170 days of exposure.

24. The dental composition of claim 23, further comprising a radiopaque material comprising approximately 4% to approximately 8% of the dental pulp healing lining or capping composition.

25. The dental composition of claim 24, further comprising a hydrophilic thickener comprising approximately 6% to approximately 9% of the dental pulp healing lining or capping composition.

26. The dental pulp healing lining or capping composition of claim 25, wherein the radiopaque material is ytterbium fluoride, barium sulfate, or bismuth oxide, and the thickener is a fumed silica.

27. The dental pulp healing lining or capping composition of claim 25, operable to biologically seal a breached pulp chamber and establish an alkaline environment therein.

28. The dental pulp healing lining or capping composition of claim 27, further operable to maintain an alkaline environment within the sealed pulp chamber for at least one year.
